(19) United States
(12) Patent Application Publication
(10) Pub. No.: US 2024/0034153 A1
(43) Pub. Date: Feb. 1, 2024

(54) POWER DISTRIBUTION SYSTEM AND METHOD FOR ISOLATING BATTERIES FOR UNINTERRUPTED SERVICE

(71) Applicant: Hyliion Inc., Cedar Park, TX (US)

(72) Inventors: Jay Kevin Neutzler, Austin, TX (US); Christopher Paul Hansen, Austin, TX (US)

(21) Appl. No.: 18/360,629

(22) Filed: Jul. 27, 2023

Related U.S. Application Data
(60) Provisional application No. 63/370,041, filed on Aug. 1, 2022.

(51) Int. Cl. B60L 3/04; H02J 7/00; H02P 27/06; B60L 58/18; B60L 50/60; B60W 20/50

(52) U.S. Cl. CPC B60L 3/04; H02J 7/007188; H02J 7/00032; H02P 27/06; B60L 58/18; B60L 50/60; B60W 20/50; H02J 2207/20; B60L 2240/545; B60L 2240/547; B60L 2240/549; B60L 2200/36

(57) ABSTRACT

A battery system having two battery packs may be configured in a high-voltage mode with the two battery packs connected in series to a converter/inverter controller. If a fault is detected with one of the batteries, selected switches are opened or closed to isolate the affected battery, whereby the battery system is configured to use the other battery to operate in a low voltage mode. A vehicle having a battery system capable of operating in either the high-voltage mode or the low-voltage mode is still capable of completing a route in the low-voltage mode. If a battery is isolated due to a transient condition, the battery system may be reconfigured to operate in the high voltage mode once the transient condition has passed.

### BENEFIT CLAIM

This application claims the benefit under 35 U.S.C. § 119(e) of provisional application 63/370,041, filed Aug. 1, 2022, the entire contents of which are hereby incorporated by reference for all purposes as if fully set forth herein.

### BACKGROUND

### Field of the Disclosure

This disclosure relates generally to controlling the operation of a powertrain in a vehicle, and more particularly, to changing the powertrain configuration to achieve optimum powertrain performance and/or attenuate a fault or failure in a component of an electric drive powertrain.

### Description of the Related Art

Electric vehicles often employ multiple batteries or battery packs to store electrical power and provide the electrical power upon demand to generate motive torque to an electric drive powertrain. The multiple batteries or battery packs in such applications are often connected in series to achieve a higher voltage, and consequently, a higher torque applied to the electric drive powertrain. If one or more of the batteries or battery packs experiences a fault or failure, such as overheating or a reduced current or voltage output, the entire battery system experiences a failure and may be rendered inoperable, thereby leaving a vehicle stranded on the roadway. Accordingly, the electric vehicle industry continues to demand increased reliability in electric drive powertrain technology.

### SUMMARY

Embodiments may be directed to a drivetrain in a vehicle, the drivetrain comprising a motor/generator (M/G) operable as a motor to receive electric power to generate rotational power and operable as a generator to receive rotational power to generate electric power and a battery system. The battery system comprises a converter/inverter controller for controlling electric power supplied to the M/G operating as a motor and electric power supplied from the M/G operating as a generator, a first battery pack and a second battery pack, wherein each of the first battery pack and the second battery pack are configured to provide electric power at a battery voltage to the converter/inverter controller via one or more paths of a plurality of paths. The battery system further comprises a plurality of switches and a battery system controller, wherein the battery system controller is configured to send a set of signals to the plurality of switches to isolate one or more of the first battery pack and the second battery pack from the converter/inverter controller or connect one or more of the first battery pack and the second battery pack to the converter/inverter controller. The battery system further comprises a set of sensors for detecting operating conditions of the first battery pack and the second battery pack and the battery system controller is communicatively coupled to each sensor in the set of sensors, the battery system controller storing instructions that when executed cause the battery system controller to communicate with each sensor in the set of sensors to detect operating conditions, including fault conditions of the first battery pack and the second battery pack.

In some embodiments, if the battery system controller detects a fault condition with the first battery pack, the battery system controller communicates a set of signals to the plurality of switches to isolate the first battery pack from the converter/inverter controller. If the battery system controller detects a fault condition with the second battery pack, the battery system controller communicates a set of signals to the plurality of switches to isolate the second battery pack. If the battery system controller does not detect any fault condition with the first battery pack or the second battery pack, the battery system controller may communicate a set of signals to the plurality of switches to connect the first battery pack and the second battery pack to the converter/inverter controller.

In some embodiments, if the battery system controller may detect a fault condition with both the first battery pack and the second battery pack, the battery system controller may communicate a set of signals to the plurality of switches to isolate both the first battery pack and the second battery pack.

In some embodiments, the battery system controller stores instructions that when executed cause the battery system controller to communicate a set of signals to the plurality of switches to connect the first battery pack and the second battery pack in parallel to the converter/inverter controller.

In some embodiments, the set of sensors comprises a first battery temperature sensor, a first battery pressure sensor, a first battery accelerometer, a second battery temperature sensor, a second battery pressure sensor, and a second battery accelerometer, and the battery system controller stores instructions that when executed cause the battery system controller to communicate with the first battery temperature sensor, the first battery pressure sensor and the first battery accelerometer to determine a first battery temperature, determine a first battery pressure and determine if the first battery pack is subjected to a contact force. If the first battery temperature equals or exceeds a first battery maximum temperature threshold, the first battery pressure equals or exceeds a first battery maximum pressure threshold or the first battery accelerometer communicates a signal indicating a large contact force, the battery system controller communicates a set of signals to the plurality of switches to isolate the first battery pack. The battery system controller stores instructions that when executed cause the battery system controller to communicate with the second battery temperature sensor, the second battery pressure sensor, and the second battery accelerometer to determine a second battery temperature, determine second battery pressure, and determine if the second battery pack is subjected to a contact force. If the second battery temperature equals or exceeds a second battery maximum temperature threshold, the second battery pressure equals or exceeds a second battery maximum pressure threshold, or the second battery accelerometer communicates a signal indicating a large contact force the battery system controller communicates a set of signals to the plurality of switches to isolate the second battery pack.

Similarly, the battery system controller can store instructions that when executed cause the battery system controller to: if the first battery temperature decreases to less than the first battery maximum temperature threshold: communicate a set of signals to the plurality of switches to connect the first battery pack to the converter/inverter controller, and if the second battery temperature decreases to less than the second battery maximum temperature threshold: communicate a set of signals to the plurality of switches to connect the second battery pack to the converter/inverter controller. The battery system controller can store instructions that when executed cause the battery system controller to: if the first battery pressure decreases to less than the first battery maximum pressure threshold: communicate a set of signals to the plurality of switches to connect the first battery pack to the converter/inverter controller, and if the second battery pressure decreases to less than the second battery maximum pressure threshold: communicate a set of signals to the plurality of switches to connect the second battery pack to the converter/inverter controller. The set of sensors can comprise a first battery voltage or current sensor and a second battery voltage or current sensor; and the battery system controller stores instructions that when executed cause the battery system controller to: communicate with the first battery voltage or current sensor and the second battery voltage or current sensor to determine a first battery voltage or a first battery current, and a second battery voltage or a second battery current, wherein if the first battery voltage or the first battery current decreases to less than a battery minimum voltage threshold or a battery minimum current threshold: communicate a set of signals to the plurality of switches to isolate the first battery pack, and if the second battery voltage or current decreases to less than the battery minimum voltage threshold or the battery minimum current threshold: communicate a set of signals to the plurality of switches to isolate the second battery pack.

In some embodiments, the drivetrain comprises an engine and a drivetrain configuration controller communicatively connected to the engine and the battery controller. If one or more of the first battery pack and the second battery pack are isolated, the battery system controller communicates a signal to the drivetrain configuration controller and the drivetrain configuration controller communicates a set of signals to operate the engine. If the first battery pack and the second battery pack are connected in series, the battery system controller communicates a signal to the drivetrain configuration controller and the drivetrain configuration controller communicates a set of signals to power down the engine.

### BRIEF DESCRIPTION OF THE DRAWINGS

For a more complete understanding of the present invention and its features and advantages, reference is now made to the following description, taken in conjunction with the accompanying drawings, in which:

FIG. 1 depicts a side partial view of one embodiment of a vehicle with a plurality of battery packs;

FIG. 2 depicts a schematic diagram of one embodiment of a drivetrain for use in the vehicle depicted in FIG. 1;

FIG. 3 depicts a diagram of a battery system;

FIG. 4 depicts a diagram of a battery system with pre-charge circuits and a discharge circuit;

FIG. 5 depicts a diagram of a drivetrain with two battery packs connected in series for high-voltage operation;

FIG. 6 depicts a diagram of a drivetrain with two battery packs, wherein only one battery pack is connected for low-voltage operation;

FIG. 7 depicts a diagram of a drivetrain with an engine and two battery packs, wherein only one battery pack is connected for low-voltage operation; and

FIG. 8 depicts a diagram of a drivetrain with an engine and two battery packs, wherein both battery packs are isolated.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, embodiments are described as they pertain to large, wheeled vehicles having a drivetrain configurable to operate using electric power supplied by a battery system to propel the vehicle and/or operate subsystems on the vehicle. However, the embodiments described herein may be applicable to any wheeled vehicle.

Each motor/generator (M/G) may operate as a motor or a generator. The engine and M/G's may be selectively coupled to drive axles, wherein selective coupling the engine to a drive axle refers to a clutch or another mechanism that may engage or disengage the engine from the drive axle and selective coupling an M/G to a drive axle refers to a clutch or other mechanism that may engage or disengage the M/G from the drive axle. Similarly, an engine may be selectively coupled to an M/G, wherein a clutch or other mechanism may engage or disengage the engine with the M/G. A battery system may be selectively connected to an M/G, wherein a switch or other mechanism may allow the battery system to supply or receive electric power to/from the M/G.

An engine control module (ECM) receives inputs from a driver and adjust operation of the engine based on the input. A transmission controller executes instructions to control operation of a transmission coupled to a drive axle. A motor controller executes instructions to determine when to operate an M/G as a motor or operate the motor/generator as a generator. A battery management system monitors a battery system to determine when the battery system can supply electric power to the motor/generator, when the battery system needs charging and when the battery system cannot or should not supply power (discharge) or receive electric power (charge).

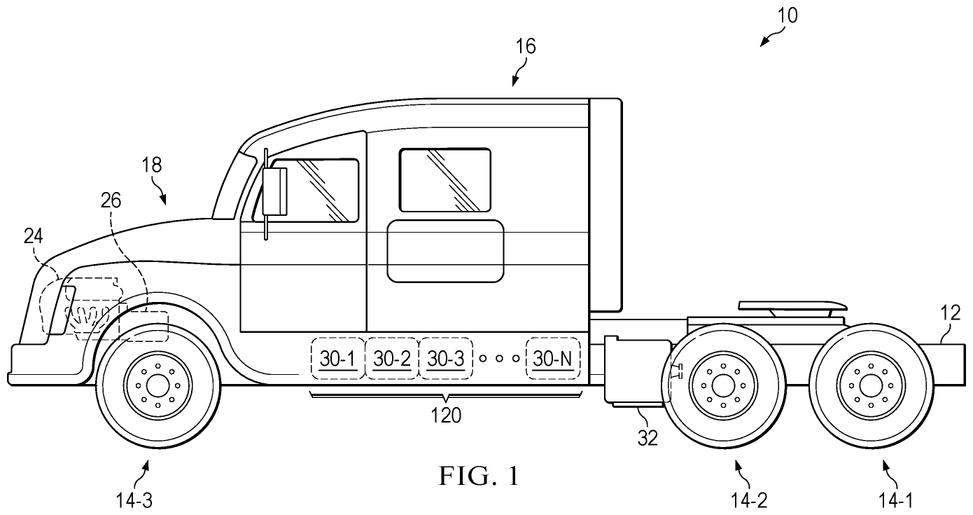

Particular embodiments may be best understood by reference to FIGS. 1-8, wherein like numbers are used to indicate like and corresponding parts.

### System Overview

Turning now to the drawings, FIG. 1 depicts a vehicle 10 comprising chassis 12, axles 14, cab 16, engine compartment 18 containing engine 24 and a first M/G 26, a plurality of battery packs 30, and a second M/G 32. The plurality of battery packs 30 may form part of the battery system 120.

Vehicle 10 is depicted as having a large cab 16 (which may be referred to as a sleeper cab) and with engine 24 located in front of cab 16. However, embodiments may work equally well with other vehicle designs, including box trucks and buses, and other cab designs, including cab-over designs. Engine 24, first M/G 26, and second M/G 32 may be selectively coupled to the drive axles 14. Battery packs 30 are depicted installed on the chassis 12 under cab 16 but may be installed in other locations on vehicle 10, including behind the cab 16 or in the engine compartment 18.

### Drivetrain

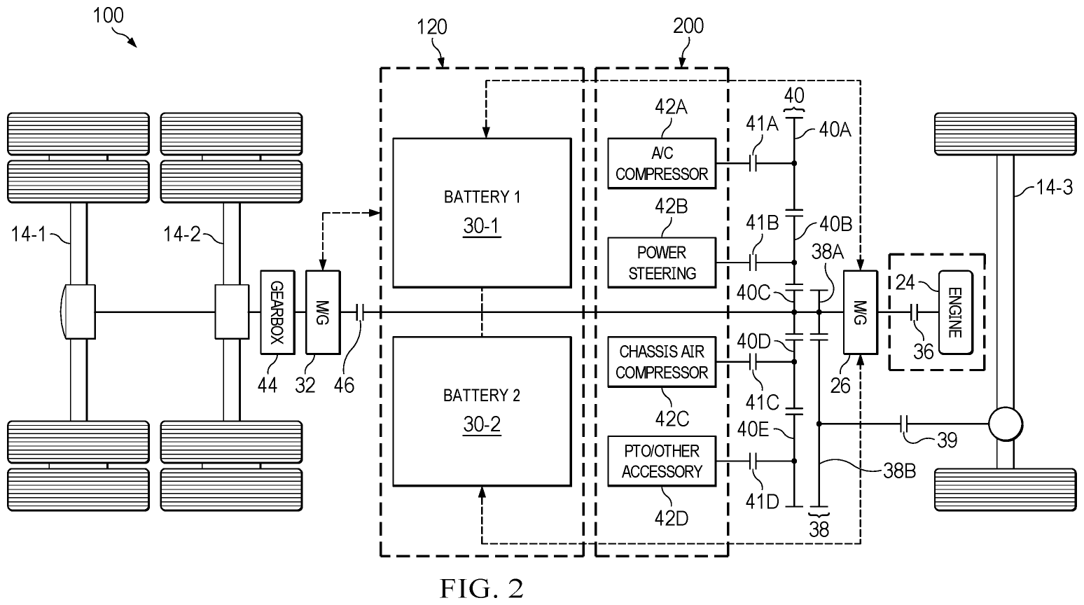

Turning to FIG. 2, drivetrain 100 comprises engine 24, first M/G 26, battery system 120 comprising a pair of battery packs 30 and second M/G 32, wherein one or more of engine 24, first M/G 26, and second M/G 32 may be engaged to one or more axles 14 for driving vehicle 10. In some embodiments, drivetrain 100 further comprises an accessory gear pass 40 with clutches 41 for selective engagement of one or more accessories 42 in accessory system 200.

In some embodiments, engine 24 may be mechanically engaged to first M/G 26 through clutch 36 when clutch 36 is closed and disengaged from M/G 26 when clutch 36 is open. In these embodiments, vehicle 10 may be agnostic to engine 24. Engine 24 may be a conventional type of fuel-fed engine such as an internal combustion (IC) engine (also referred to as an ICE) that may be configured to operate using gasoline, diesel, natural gas (NG) including compressed natural gas (CNG), liquid natural gas (LNG) and renewable natural gas (RNG), or some other type of engine including, but not limited to gas turbines and fuel cells, which may operate on hydrogen, natural gas, propane or some other fuel source.

### Series Hybrid Drivetrain Configurations

In some embodiments, engine 24 is coupled only to the first M/G 26, wherein engine 24 supplies rotational power to only the first M/G 26 in a series hybrid drivetrain configuration.

In a first series hybrid drivetrain configuration, engine 24 supplies rotational power only to first M/G 26 to generate electric power to charge battery system 120. In this first series hybrid drivetrain configuration, the battery system 120 is connected to the second M/G 32, and the second M/G 32 is selectively coupled to drive axle 14-2. Electric power from the battery system 120 may be supplied to the second M/G 32 operating as a motor to propel vehicle 10.

In a second series hybrid drivetrain configuration, engine 24 supplies rotational power only to the first M/G 26 to generate electric power to transmit to the second M/G 32 operating as a motor and that is selectively coupled to drive axle 14-2 to propel the vehicle 10.

In a third series hybrid drivetrain configuration, engine 24 supplies rotational power only to the first M/G 26 to generate electric power, wherein electric power generated by the first M/G 26 and electric power discharging from the battery system 120 are transmitted to the second M/G 32 that is selectively coupled to drive axle 14-2 and operating as a motor to propel the vehicle 10.

In some drivetrain configurations, engine 24 is coupled to drive axle 14-2 but disengaged from first M/G 26, wherein engine 24 supplies rotational power only to drive axle 14-2 to propel the vehicle 10. The battery system 120 may transmit electric power to other systems (e.g., a cabin heating and cooling system), but the engine 24 provides all the rotational power to propel the vehicle 10.

In some drivetrain configurations, engine 24 supplies rotational power only to the first M/G 26 to generate electric power, wherein the electric power generated by the first M/G 26 is transmitted to an external electric power system (not shown).

Embodiments of vehicle 10 with engine 24 coupled to first M/G 26 only may facilitate the installation of high-density engines 24 with smaller displacements. For example, embodiments may utilize a conventional diesel engine with a displacement between 6-12 liters instead of a 15-liter displacement. If a smaller engine 24 is installed in vehicle 10, vehicle 10 may have more room for additional components, or installation and removal of engine 24 may be easier. In various embodiments, vehicle 10 may be configured with standardized mounts in an engine compartment 18 to allow vehicle 10 to be outfitted with different types of engines 24 or to install battery packs 30.

First M/G 26 may operate as a motor or a generator. In some embodiments, the first M/G 26 may be sized based on the operating range of engine 24. For example, a turbine engine 24 may have an operating range of 40,000-120,000 RPM, and the first M/G 26 may be sized to generate electric power efficiently for that operating range. As another example, vehicle 10 may be outfitted with a diesel engine 24 having a preferred operating range of 1200-2400 RPM, and the first M/G 26 may be sized to generate electric power efficiently for that operating range. The ability to operate engine 24 within a preferred operating range may increase the efficiency and/or service life of engine 24. In some embodiments, vehicle 10 may use a de-contented engine 24 with a lower power rating or higher durability by operating engine 24 within a smaller operating range. For example, the diesel engine 24 mentioned above may have an operating range of 800-3000 RPM, a preferred operating range of 1200-2400 RPM, and an optimal operating range of 1500-1800 RPM.

In some embodiments, engine 24 and the first M/G 26 may be integrated as a single unit. Integrating engine 24 and the first M/G 26 in a single unit may reduce the overall size of engine compartment 18 needed to contain engine 24. In some embodiments, a modular design with engine 24, first M/G 26, and clutch 36 integrated as a single unit may be easier to connect to standardized mount locations and may have fewer connections and couplings for easier installation, maintenance, and/or removal from vehicle 10.

During the operation of vehicle 10, engine 24 may be powered on and clutch 36 may be closed to engage engine 24 to first M/G 26. In some configurations, rotational power supplied by engine 24 to first M/G 26 generates electric power only. The electric power may be used to charge one or more battery packs 30 in the battery system 120 or may be transmitted to components directly. In some configurations, rotational power supplied by engine 24 to first M/G 26 generates rotational power only. In some configurations, rotational power supplied by engine 24 to first M/G 26 generates rotational power and electric power.

In some embodiments, drivetrain 100 comprises front axle gear pass 38 for transferring rotational power from first M/G 26 to front axle 14-3 when clutch 39 is engaged or closed. When clutch 39 is disengaged or open, no rotational power is transferred to or from front axle 14-3.

In some embodiments, drivetrain 100 comprises accessory gear pass 40 for transferring rotational power to one or more accessories 42 (e.g., accessories 42A-42D). In some configurations, when clutch 36 is open and clutch 46 is open, rotational power from first M/G 26 may be transmitted to accessory gear pass 40. In some configuration, when clutch 36 is open and clutch 46 is closed, rotational power from second M/G 32 may be transmitted to accessory gear pass 40.

In some embodiments, all accessories 42 may be coupled to accessory gear pass 40 such that any power needed by accessories 42 comprises rotational power supplied by first M/G 26. In some configurations, when engine 24 is active and engaged with first M/G 26 through clutch 36, rotational power needed by accessories 42 comprises rotational power supplied by engine 24. In some configurations, when engine 24 is disengaged from the first M/G 26, rotational power needed by accessories 42 comprises rotational power supplied by the first M/G 26. In some embodiments, vehicle 10 may be configured with engine 24 coupled to the first M/G 26, such that the first M/G 26 replaces the alternator and power generated by the first M/G 26 operates a water pump and any accessories. Using this arrangement, the displacement and overall size associated with engine 24 may be reduced and components and accessories 42 may be located elsewhere in an engine compartment 18, including elsewhere on chassis 12 of vehicle 10. By way of background, in a traditional drivetrain for vehicle 10, an internal combustion engine (ICE) 24 is mechanically coupled to a water pump, and the ICE is further coupled to accessories 42 via a belt. The accessories may include an air conditioning (A/C) compressor 42A, an alternator (not shown), a power steering pump 42B, and/or a chassis air compressor 42C. Thus, engine 24 in a traditional drivetrain needs to be large enough to propel vehicle 10 and provide rotational power to the water pump and all accessories associated with the belt. The additional power demands result in engine 24 being engineered larger to be able to operate over a wide range of operating speeds and loads, adding cost and complexity.

One or more of clutches 41 may be open or closed to manage power supplied to accessories 42. For example, clutch 41A may be closed to engage first M/G 26 to air conditioning (A/C) compressor 42A such that rotational power from first M/G 26 is supplied to air conditioning (A/C) compressor 42A, clutch 41B may be closed to engage first M/G 26 to power steering pump 42B such that rotational power from first M/G 26 is supplied to power steering pump 42B, clutch 41C may be closed to engage first M/G 26 to chassis air compressor 42C such that rotational power from first M/G 26 is supplied to chassis air compressor 42C and clutch 41D may be closed to engage first M/G 26 to power take-off (PTO) or some other accessory 42D such that rotational power from first M/G 26 is supplied to other accessories such as power take-off (PTO)/other accessory 42D. Clutches 36 and 41 may be unidirectional such that rotational power passes through clutches 36 and 41 in only one rotation direction.

Drivetrain 100 further includes the second M/G 32 configurable to operate as a motor or a generator. In some embodiments, a second M/G 32 may be sized based on a desired output power to one or more rear axles 14-1 and 14-2. For example, in some embodiments, a second M/G 32 may be configured to supply an output power of 500 horsepower (hp) or more to gearbox 44 for output to one or more rear axles 14-1 and 14-2.

Vehicle 10 may have two rear axles 14-2, 14-1. As depicted in FIG. 2, in some embodiments, vehicle 10 comprises gearbox 44 coupled to rear axles 14-1 and 14-2 and a second M/G 32 coupled to gearbox 44. Rotational power from one or more of engine 24, first M/G 26, and second M/G 32 may be supplied to gearbox 44 for supplying rotational power to one or more of rear axles 14-1 and 14-2. In some embodiments (not shown), a second M/G 32 may be coupled to each rear axle 14-1 and 14-2.

For ease of understanding symbols in the drawings, when referring to clutches 36, 39, 41A-41D, and 46, two parallel lines indicate an open position and a solid black box indicates a closed position. When referring to electric power, a heavy dashed line indicates electric power is being transferred, wherein an arrow indicates the direction of transfer.

### Battery System

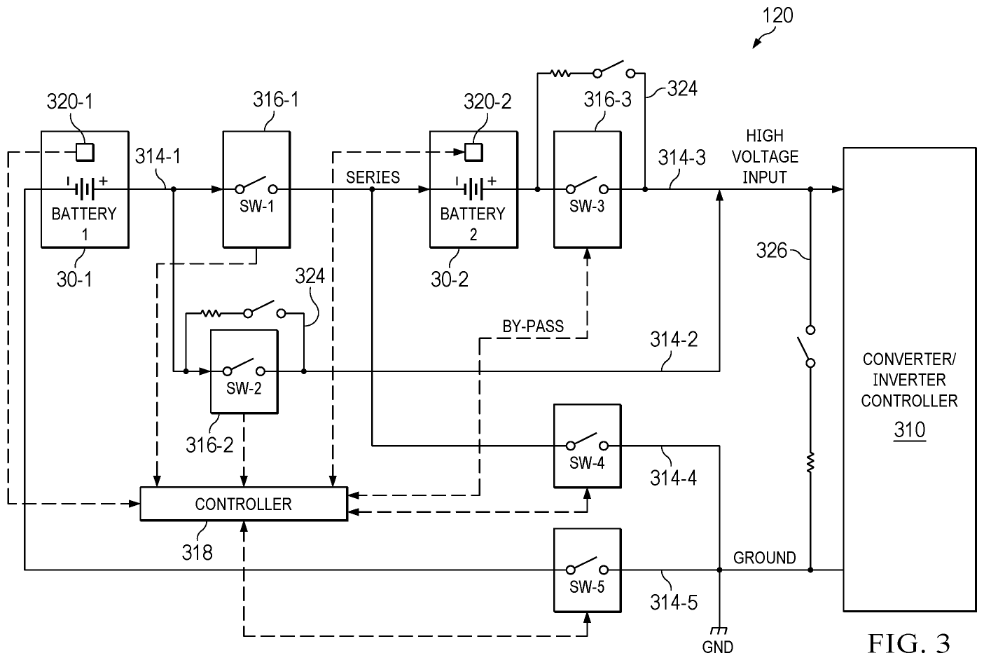

FIG. 3 depicts a diagram of one embodiment of a battery system 120 for use in vehicles 10. As depicted in FIG. 3, battery system 120 for vehicle 10 comprises converter/inverter controller 310, two battery packs 30 including at least first battery pack 30-1 and second battery pack 30-2, a plurality of switches 316 (also referred to as a “switching logic”) for routing power via a plurality of paths 314, a battery system controller 318, a set of sensors 320, pre-charge circuits 324 and discharge circuit 326. In some embodiments, the battery system 120 may comprise more than two battery packs 30. In some embodiments, each battery pack 30-1, 30-2 includes one or more batteries, cells, or the like. For example, the first battery pack 30-1 may comprise a plurality of batteries, and the second battery pack 30-2 may comprise a plurality of batteries.

First battery pack 30-1 and second battery pack 30-2 are each configured to provide electric power at a battery voltage (e.g., 375 VDC) to converter/inverter controller 310 via one or more paths from among the plurality of paths 314.

A first path 314-1 may originate at first battery pack 30-1 and terminate at second battery pack 30-2, wherein first switch 316-1 is located on path 314-1 between first battery pack 30-1 and second battery pack 30-2.

A second path 314-2 may originate at first battery pack 30-1 and terminate at converter/inverter controller 310, wherein second switch 316-2 is located on path 314-2 between the first battery pack 30-1 and converter/inverter controller 310.

A third path 314-3 may originate at second battery pack 30-2 and terminate at converter/inverter controller 310, wherein third switch 316-1 is located on path 314-3 between the second battery pack 30-2 and converter/inverter controller 310.

A fourth path 314-4 may be originated at converter/inverter controller 310 and terminate on first path 314-1 between first switch 316-1 and second battery pack 30-2, wherein fourth switch 316-4 is located on path 314-4 between converter/inverter controller 310 and first path 314-1.

A fifth path 314-5 may originate at converter/inverter controller 310 and terminate at first battery pack 30-1, wherein fifth switch 316-5 is located on path 314-5 between converter/inverter controller 310 and first battery pack 30-1.

Sensors 320-1 and 320-2 detect the operating conditions of the first battery pack 30-1 and the second battery pack 30-2, respectively. Sensors 320 may comprise a battery temperature sensor, a pressure sensor, a voltage sensor, a current sensor, or an accelerometer, for example. Operating conditions may be values such as battery temperature, battery pressure, current, voltage, or contact force value.

Battery system controller 318 communicatively coupled to each sensor 320 and communicatively coupled to each switch among the plurality of switches 316 may store instructions that, when executed by the battery system controller, cause battery system controller 318 to communicate with each sensor 320 in the set of sensors 320 to receive signals corresponding to operating conditions of the first battery pack 30-1 and second battery pack Battery system controller 318 may determine an operating condition associated with one or more of the first battery pack 30-1 and the second battery pack 30-2, such as a battery temperature exceeding a maximum battery temperature threshold, a battery pressure exceeding a maximum battery pressure threshold, a battery pressure decreasing to less than or dropping below a minimum battery pressure threshold, a battery voltage decreasing to less than or dropping below a minimum battery voltage threshold, a battery current decreasing to less than or dropping below a minimum battery current threshold, or an accelerometer signal indicating a contact force on a battery pack has exceeded a maximum allowable contact force. Battery system controller 318 may communicate signals to switches 316 based on the operating conditions.

FIG. 3 further depicts a diagram of one embodiment of a battery system 120 with pre-charge circuits 324 and a discharge circuit 326 for use in vehicles 10. As depicted in FIG. 3, pre-charge circuit 324-1 may be associated with battery pack 30-1, and pre-charge circuit 324-4 may be associated with battery pack 30-2.

Under certain circumstances, a battery pack 30 installed in the battery system 120 may have a low voltage, or there may be a voltage differential between two battery packs 30. This is undesired when connecting the two battery packs 30-1, 30-2.

For example, if the battery system controller 318 isolates one battery pack (e.g., first battery pack 30-1) due to a detected fault condition or other condition, another battery pack 30 (e.g., second battery pack 30-2) may be used to supply all electrical power. In some embodiments where one battery pack 30 is removed from the circuit, the faulty battery pack 30 may be at a first voltage (e.g., first battery pack 30-1 may have a total charge capacity of 375 V and be at a voltage of 20% of its total charge capacity) and another battery pack 30 may be at a second voltage (e.g., second battery pack 30-2 may have a total charge capacity of 375 V and be at a voltage corresponding to 90% of its total charge capacity). If the battery system controller 318 connects the two battery packs 30, the voltage differential between the first battery pack 30-1 and the second battery pack 30-2 may cause a large inrush current to the first battery pack 30-1, which may damage one or both battery packs 30.

Embodiments may execute a pre-charge routine before connecting a battery pack 30 with a low voltage or connecting two battery packs 30 when a large voltage differential exists. In some embodiments, the battery system controller 318 may communicate with each of the first battery pack 30-1 and second battery pack 30-2 to determine a respective voltage or charge level for each battery pack 30. If the voltage in each battery pack 30 decreases to or is less than a minimum voltage (e.g., 50 Volts) or percentage of its total charge capacity (e.g., 20%), the battery system controller 318 may communicate a set of signals to increase the voltage in the battery pack 30 prior to connecting it into the circuit with the other battery pack 30. Using the example above, if the battery system controller 318 determines first battery pack 30-1 is at Volts and the minimum voltage is 50 Volts, the battery system controller 318 may communicate signals to pre-charge circuit 324-2 to charge first battery pack 30-1 to at least 50 Volts before connecting second battery pack 30-2.

In some embodiments, the battery system controller 318 may communicate with each of the first battery pack 30-1 and second battery pack 30-2 to determine a voltage differential between the first battery pack 30-1 and second battery pack 30-2. The battery system controller 318 may store a value for a maximum voltage differential, for example 10%, 5%, or some other value, and may be configured to pre-charge a battery pack 30 to within the threshold prior to connecting the battery packs 30.

In some embodiments, if a voltage differential between two battery packs 30-1 and 30-2 is greater than a maximum voltage differential threshold, the battery system controller 318 may signal a pre-charge circuit 324 to enable charging the battery pack 30 with the lower voltage until the voltage differential decreases to or is less than the maximum voltage differential threshold. For example, the battery system controller 318 may communicate with first battery pack 30-1 and determine first battery pack 30-1 is at 40% charge capacity, communicate with second battery pack 30-2 and determine second battery pack 30-2 is at 90% charge capacity and determine a voltage differential of 50%. The battery system controller 318 may signal pre-charge circuit 324-1 to enable charging first battery pack 30-1 until the voltage differential decreases to or is less than the maximum voltage differential threshold. In some embodiments, discharge circuit 326 enables the battery system controller 318 to safely discharge one or more battery packs 30 in battery system 120. In some embodiments, the battery system controller 318 may perform a pre-charge routine before connecting battery packs 30 to converter/inverter controller 310, including before connecting the first battery pack, before connecting the second battery pack, or a combination thereof. A pre-charge routine may include verifying each battery pack 30 has a voltage greater than a battery minimum voltage threshold (e.g., 50 Volts or 20%) and that a voltage differential between battery packs 30 decreases to or is less than a maximum voltage differential threshold (e.g., 5%). A pre-charge routine may include charging one or more battery packs 30 to have a voltage greater than a battery minimum voltage threshold and/or charging one or more battery packs 30 such that a voltage differential decreases to or is less than a maximum voltage differential. Accordingly, it will be appreciated that the pre-charge circuits 324 and discharge circuit 326 may prevent damage to the battery packs 30.

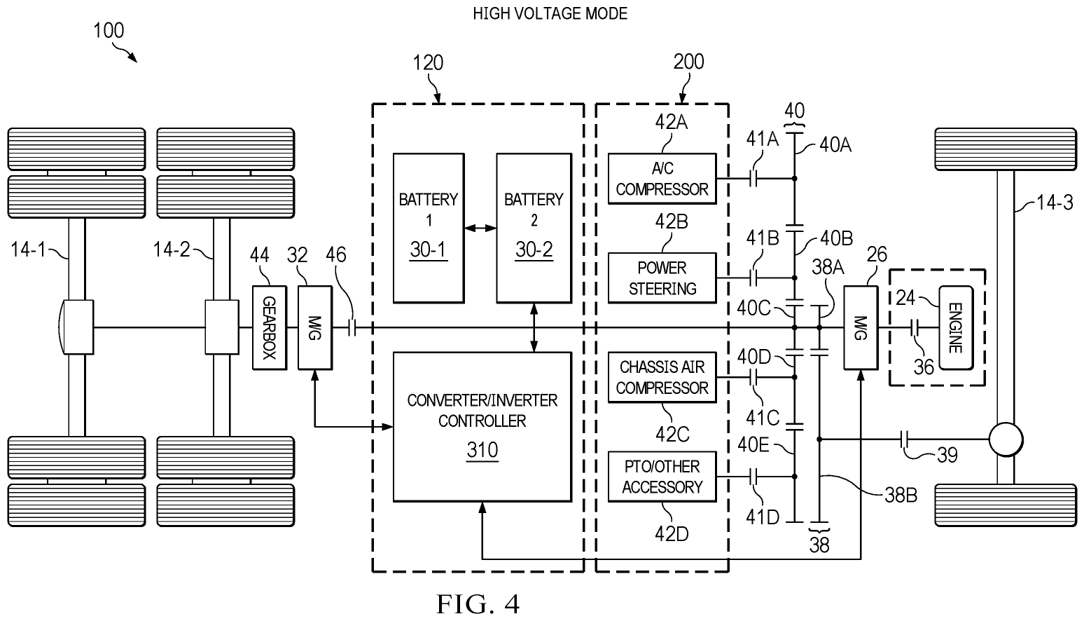

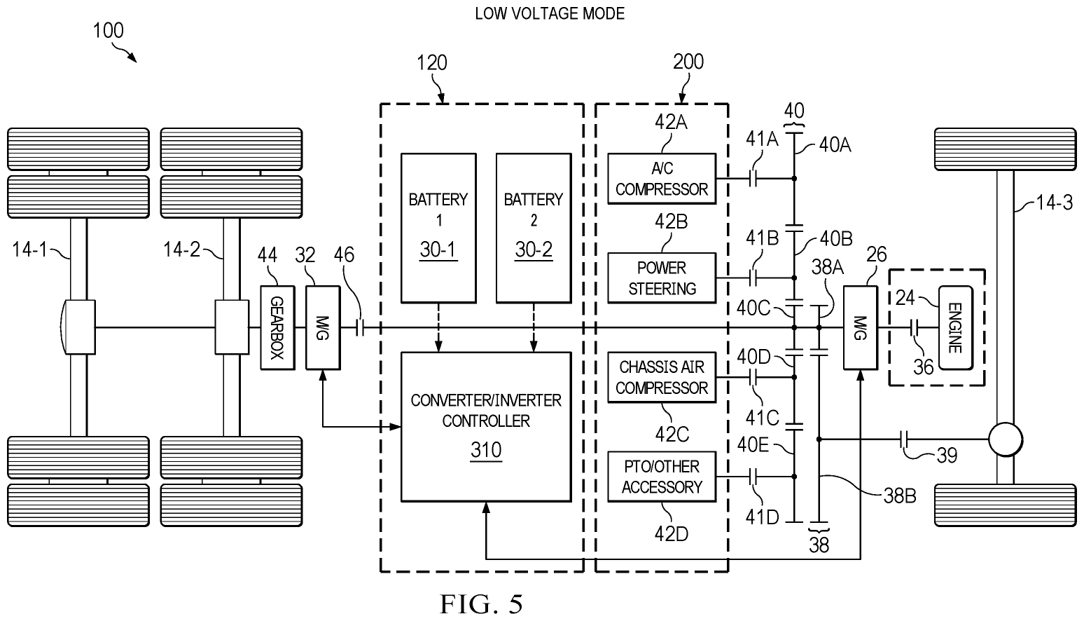

Referring to FIGS. 4 and 5, embodiments of the battery system 120 may operate in different modes.

### High-Voltage Mode

If the battery system controller 318 determines there are no fault conditions with either the first battery pack 30-1 or second battery pack 30-2, the battery system controller 318 may execute instructions to a plurality of switches 316 to connect the first battery pack 30-1 and second battery pack 30-2 in series. In some embodiments, battery system controller 318 communicates a set of signals to open the second switch 316-2 and the fourth switch 316-4 and communicates a set of signals to close the first switch 316-1, the third switch 316-3 and the fifth switch 316-5, wherein the first battery pack 30-1 and second battery pack 30-2 are connected in series to converter/inverter controller 310. For battery packs 30 rated at 375 VDC, battery packs 30-1 and 30-2 connected in series may supply electric power at 750 VDC to converter/inverter controller 310.

### Low Voltage Mode—Isolating the First Battery Pack

If the battery system controller 318 determines, based on an operating condition, a fault condition with the first battery pack 30-1, battery system controller 318 may execute instructions to isolate first battery pack 30-1. In some embodiments, battery system controller 318 communicates a set of signals to open first switch 316-1, second switch 316-2, and fifth switch 316-5 to isolate first battery pack 30-1. Battery system controller 318 may also communicate a set of signals to close third switch 316-3 and fourth switch 316-4, wherein second battery pack 30-2 is connected to converter/inverter controller 310. For battery packs rated at 375 VDC, the second battery pack 30-2 may supply electric power at 375 VDC to converter/inverter controller 310. In some embodiments, battery system controller 318 stores information about battery system 120, such as values for operating conditions of first battery pack 30-1 and second battery pack 30-2.

### Low Voltage Mode—Isolating the Second Battery Pack

If the battery system controller 318 determines, based on an operating condition, a fault condition with the second battery pack 30-2, battery system controller 318 may execute instructions to isolate second battery pack 30-2. In some embodiments, battery system controller 318 communicates a set of signals to open first switch 316-1, third switch 316-3, and fourth switch 316-4 to isolate second battery pack 30-1. Battery system controller 318 may also communicate a set of signals to close second switch 316-2 and fifth switch 316-5, wherein first battery pack 30-1 is connected to converter/inverter controller 310. For battery packs 30 rated at 375 VDC, first battery pack 30-1 may supply electric power at 375 VDC to converter/inverter controller 310. In some embodiments, battery system controller 318 stores information about battery system 120, such as values for operating conditions of first battery pack 30-1 and second battery pack 30-2.

### Low-Voltage Operation

In some embodiments, battery system controller 318 may communicate a set of signals to open first switch 316-2 and communicate a set of signals to close second switch 316-1, third switch 316-3, fourth switch 316-4, and fifth switch 316-5, wherein both first battery pack 30-1 and second battery pack 30-2 are connected in parallel to converter/inverter controller 310. For battery packs 30 rated at 375 VDC, battery packs 30-1 and 30-2 may each supply electric power at 375 VDC to converter/inverter controller 310. In some embodiments, battery system controller 318 stores information about battery system 120, such as values for operating conditions of first battery pack 30-1 and second battery pack 30-2.

### Drivetrain Configuration—all Electric/High Voltage Mode

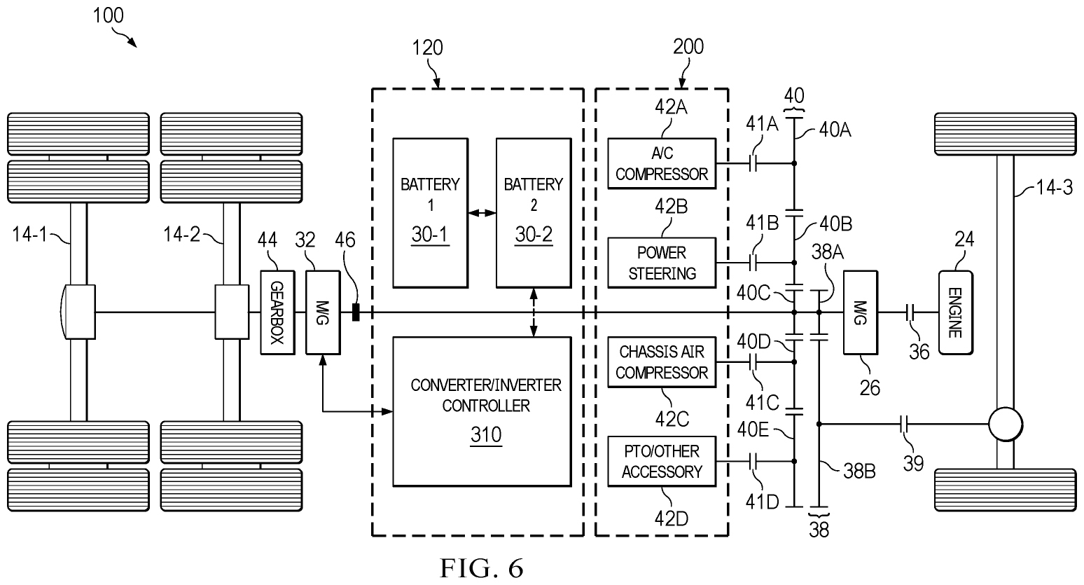

Referring to FIG. 6, in some embodiments, drivetrain 100 may be configured with first M/G 26 disengaged from engine 24 such that battery packs 30 in battery system 120 supply electric power to second M/G 32 operating as a motor to supply rotational power to one or more of the rear axles 14-1 and 14-2 to drive vehicle 10 and supply electric power to first M/G 26 operating as a motor to supply rotational power to gear pass 40 to operate accessories 42. A drivetrain controller (not shown) may signal battery system 120 to supply electric power to second M/G 32, signal second M/G 32 to operate as a motor to generate rotational power, and signal clutch 46 to close, wherein rotational power generated by M/G 32 is transmitted through gearbox 44 to one or more of rear axles 14-1 and 14-2 to drive vehicle 10 and rotational power is supplied to accessory gear pass 40 for operating one or more accessories 42A-42D.

### Drivetrain Configuration—all Electric/Low Voltage Mode

Referring to FIG. 6, in some embodiments, drivetrain 100 may be configured with first M/G 26 disengaged from engine 24 such that battery packs 30 in battery system 120 supply electric power to second M/G 32 operating as a motor to supply rotational power to one or more of the rear axles 14-1 and 14-2 to drive vehicle 10 and supply electric power to first M/G 26 operating as a motor to supply rotational power to gear pass 40 to operate accessories 42. A sensor in battery system 120 may detect an operating condition associated with a battery pack 30 such that high-voltage operation is not possible or should not be allowed. A battery system controller 318 (not shown in FIG. 6) may communicate a set of signals to configure battery system 120 such that only one of first battery pack 30-1 or second battery pack 30-2 supplies electric power (indicated by dashed lines).

A drivetrain controller (not shown) may signal battery system 120 to supply electric power to second M/G 32 and signal second M/G 32 to operate as a motor to generate rotational power to propel vehicle 10, wherein rotational power generated by M/G 32 is transmitted through gearbox 44 to one or more of rear drive axles 14-1 and 14-2 to drive vehicle 10. In some embodiments, a drivetrain controller may signal clutch 46 to close, wherein rotational power generated by M/G 32 is also supplied to accessory gear pass 40 for operating one or more accessories 42A-42D.

Configurations such as depicted in FIG. 6 may be implemented based on vehicle characteristics and characteristics of the route on which vehicle 10 is traveling. For example, if vehicle 10 is traveling in a zero-emissions zone, operating engine 24 may not be possible, or if vehicle 10 is very light or traveling mostly downhill, operating engine 24 may not be necessary.

### Drivetrain Configuration Based on Low Voltage Mode

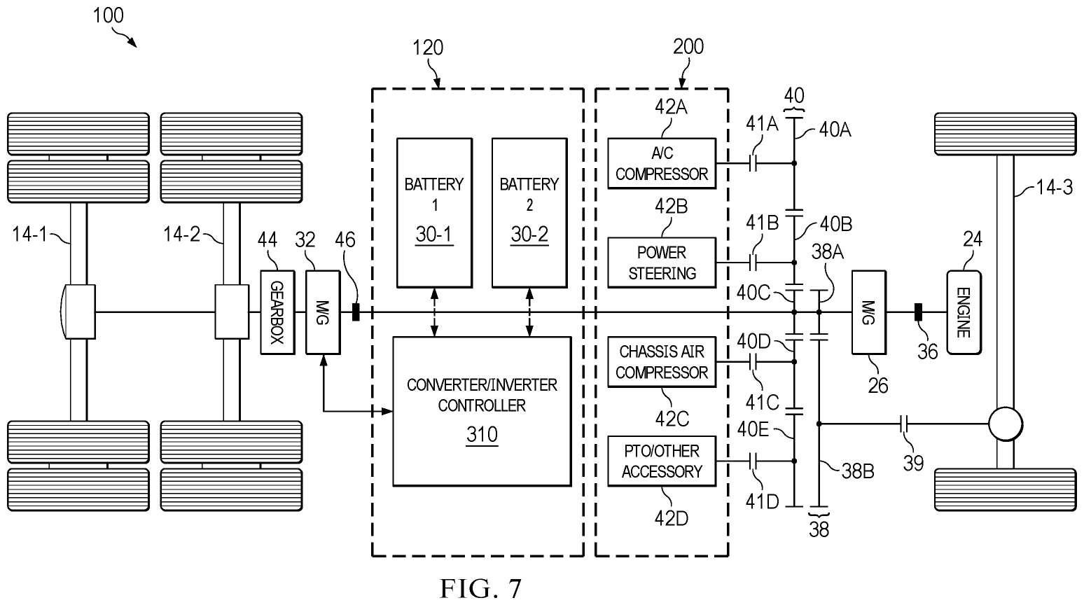

Referring to FIG. 7, in some embodiments, drivetrain 100 may be configured with first M/G 26 engaged to engine 24. Battery packs 30 in battery system 120 may supply electric power to second M/G 32 operating as a motor to supply rotational power to one or more of rear axles 14-1 and 14-2 to drive vehicle 10. Engine 24 may supply rotational power through first M/G 26 operating as a motor or generator to supply rotational power to gear pass 40 to operate accessories 42.

A sensor in battery system 120 may detect a fault condition with a battery pack 30 such that high-voltage operation is not possible or should not be allowed. A battery system controller 318 (not shown in FIG. 7) may communicate a set of signals to configure battery system 120 such that only one of first battery pack 30-1 or second battery pack 30-2 supplies electric power (indicated by dashed lines).

A drivetrain controller (not shown) may signal battery system 120 to supply electric power to second M/G 32 and signal second M/G 32 to operate as a motor to generate rotational power to propel vehicle 10, wherein rotational power generated by M/G/32 is transmitted through gearbox 44 to one or more of rear axles 14-1 and 14-2 to drive vehicle 10. In some embodiments, a drivetrain controller may signal engine 24 to operate and signal clutch 36 to close, wherein rotational power generated by engine 24 is supplied to accessory gear pass 40 for operating one or more accessories 42A-42D.

Configurations such as those depicted in FIG. 7 may be implemented based on vehicle characteristics and characteristics of the route on which vehicle 10 is traveling. For example, if vehicle 10 is not traveling in a zero-emissions zone, operating engine 24 may be possible, and if vehicle 10 is very heavy or traveling mostly uphill, operating engine 24 may be necessary.

### Battery Pack Bypass

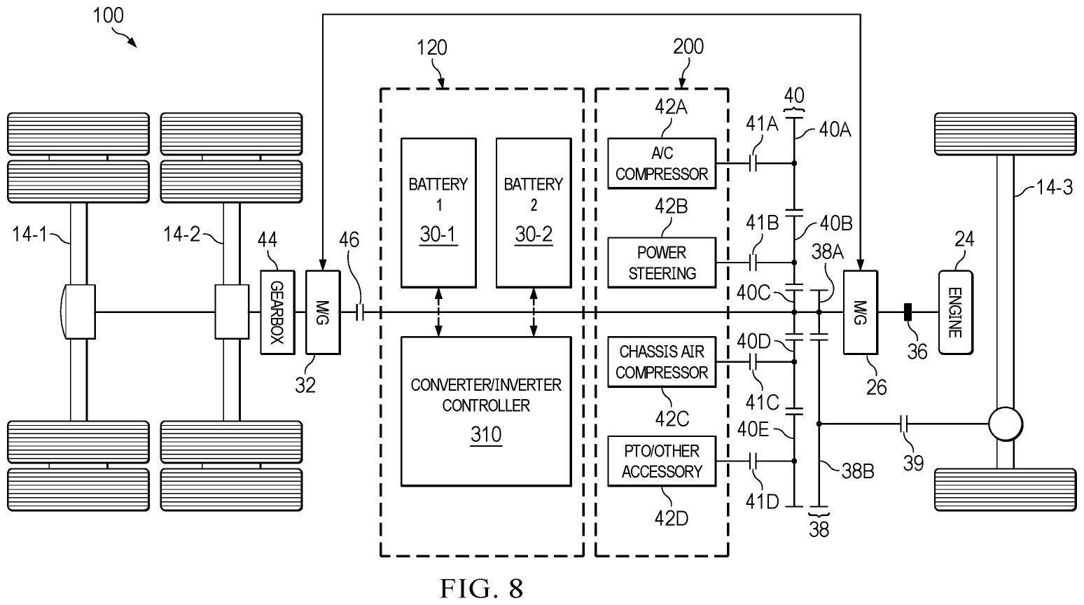

Referring to FIG. 8, in some embodiments, drivetrain 100 may be configured with engine 24 coupled to first M/G 26 operating as a generator for supplying electric power to second M/G 32, wherein battery packs 30 are isolated (i.e., neither charged nor discharged). A drivetrain controller (not shown) may signal engine 24 to operate and signal clutch 36 to close, such that rotational power from engine 24 is supplied to first M/G 26. The drivetrain controller may signal first M/G 26 to operate as a generator to supply electric power to second M/G 32 to generate rotational power and signal clutch 46 to open, wherein rotational power from second M/G 32 is supplied to one or more of the rear axles 14-1 and 14-2 via gearbox 44 to drive the vehicle 10. Rotational power from first M/G 26 may be transmitted to accessory gear pass 40 for operating one or more accessories 42A-42D. The controller may signal clutches 41A and 41B to close to engage accessories A/C compressor 42A and power steering pump 42B with accessory gear pass 40 such that rotational power is supplied to A/C compressor 42A through clutch 41A and supplied to power steering pump 42B through clutch 41B.

The configuration depicted in FIG. 8 may represent a configuration of vehicle 10 in which operation of the vehicle 10 using battery 30 is undesirable, such as when the operating temperature of both battery packs 30 is outside a range of desired operating temperatures. Engine 24 may supply rotational power to accessory gear pass 40 for operating one or more accessories 42 as part of a thermal management system. The thermal management system may include A/C compressor 42A as part of a refrigerant system configurable for maintaining an operating temperature of battery packs 30 within a range of operating temperatures and maintaining a desired temperature inside cab 16 for a driver.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A battery system for a vehicle with a drivetrain comprising a motor/generator (M/G) operable as a motor to receive electric power to generate rotational power and operable as a generator to receive rotational power to generate electric power, the battery system comprising:
a converter/inverter controller for controlling electric power supplied to the M/G operating as a motor and electric power supplied from the M/G operating as a generator;
a first battery pack;
a second battery pack, wherein each of the first battery pack and the second battery pack is configured to provide electric power at a battery voltage to the converter/inverter controller via one or more paths of a plurality of paths; and
a battery system controller communicatively coupled to a plurality of switches, the battery system controller storing instructions that when executed cause the battery system controller to communicate a set of signals to the plurality of switches to isolate the first battery pack or the second battery pack from the converter/inverter controller.

2. The battery system of claim 1, wherein the battery system controller stores instructions that when executed cause the battery system controller to communicate a set of signals to the plurality of switches to isolate both the first battery pack and the second battery pack from the converter/inverter controller.

3. The battery system of claim 1, wherein the battery system controller stores instructions that when executed cause the battery system controller to communicate a set of signals to the plurality of switches to connect the first battery pack and the second battery pack in parallel to the converter/inverter controller.

4. The battery system of claim 1, further comprising a set of sensors, wherein:
the set of sensors comprises a first battery temperature sensor and a second battery temperature sensor; and
the battery system controller stores instructions that when executed cause the battery system controller to:
communicate with the first battery temperature sensor and the second battery temperature sensor to determine a first battery temperature and a second battery temperature, wherein
if the first battery temperature equals or exceeds a first battery maximum temperature threshold:
communicate a set of signals to the plurality of switches to isolate the first battery pack; and
if the second battery temperature equals or exceeds a second battery maximum temperature threshold:
communicate a set of signals to the plurality of switches to isolate the second battery pack.

5. The battery system of claim 4, wherein the battery system controller stores instructions that when executed cause the battery system controller to:
if the first battery temperature decreases to less than the first battery maximum temperature threshold:
communicate a set of signals to the plurality of switches to connect the first battery pack to the converter/inverter controller; and
if the second battery temperature decreases to less than the second battery maximum temperature threshold:
communicate a set of signals to the plurality of switches to connect the second battery pack to the converter/inverter controller.

6. The battery system of claim 1, further comprising a set of sensors, wherein:
the set of sensors comprises a first battery pressure sensor and a second battery pressure sensor; and
the battery system controller stores instructions that when executed cause the battery system controller to:
communicate with the first battery pressure sensor and the second battery pressure sensor to determine a first battery pressure and a second battery pressure, wherein
if the first battery pressure equals or exceeds a first battery maximum pressure threshold:
communicate a set of signals to the plurality of switches to isolate the first battery pack from the converter/inverter controller; and
if the second battery pressure equals or exceeds a second battery maximum pressure threshold:
communicate a set of signals to the plurality of switches to isolate the second battery pack from the converter/inverter controller.

7. The battery system of claim 6, wherein the battery system controller stores instructions that when executed cause the battery system controller to:
if the first battery pressure decreases to less than the first battery maximum pressure threshold:
communicate a set of signals to the plurality of switches to connect the first battery pack to the converter/inverter controller; and
if the second battery pressure decreases to less than the second battery maximum pressure threshold:
communicate a set of signals to the plurality of switches to connect the second battery pack to the converter/inverter controller.

8. The battery system of claim 1, further comprising a set of sensors, wherein:
the set of sensors comprises a first battery accelerometer and a second battery accelerometer; and
the battery system controller stores instructions that when executed cause the battery system controller to:
communicate with the first battery accelerometer and the second battery accelerometer to determine a contact force on one or more of the first battery pack and the second battery pack, wherein
if the first battery accelerometer communicates a signal indicating a large contact force:
communicate a set of signals to the plurality of switches to isolate the first battery pack from the converter/inverter controller; and
if the second battery accelerometer communicates a signal indicating a large contact force:
communicate a set of signals to the plurality of switches to isolate the second battery pack from the converter/inverter controller.

9. The battery system of claim 1, further comprising a set of sensors, wherein:
the set of sensors comprises a first battery voltage or current sensor and a second battery voltage or current sensor; and
the battery system controller stores instructions that when executed cause the battery system controller to:
communicate with the first battery voltage or current sensor and the second battery voltage or current sensor to determine a first battery voltage or a first battery current, and a second battery voltage or a second battery current, wherein
if the first battery voltage or the first battery current decreases to less than a battery minimum voltage threshold or a battery minimum current threshold:
communicate a set of signals to the plurality of switches to isolate the first battery pack; and
if the second battery voltage or current decreases to less than the battery minimum voltage threshold or the battery minimum current threshold:
communicate a set of signals to the plurality of switches to isolate the second battery pack.

10. The battery system of claim 9, wherein the battery system controller stores instructions that when executed cause the battery system controller to:
if the first battery voltage or the first battery current increases to equal to or greater than the battery minimum voltage threshold or the battery minimum current threshold:
communicate a set of signals to the plurality of switches to connect the first battery pack to the converter/inverter controller; and
if the second battery voltage or the second battery current increases to equal to or greater than the battery minimum voltage threshold or the battery minimum current threshold:
communicate a set of signals to the plurality of switches to connect the second battery pack to the converter/inverter controller.

11. The battery system of claim 1, wherein the battery system controller executes instructions to perform a pre-charge routine prior to connecting the first battery pack, the second battery pack, or a combination thereof to the converter/inverter controller.

12. A drivetrain in a vehicle, the drivetrain comprising:
a motor/generator (M/G) operable as a motor to receive electric power to generate rotational power and operable as a generator to receive rotational power to generate electric power; and
a battery system comprising:
a converter/inverter controller for controlling electric power supplied to the M/G operating as a motor and electric power supplied from the M/G operating as a generator;
a first battery pack and a second battery pack, wherein each of the first battery pack and the second battery pack are configured to provide electric power at a battery voltage to the converter/inverter controller via one or more paths of a plurality of paths;
a plurality of switches for selecting one or more paths of the plurality of paths; and
a battery system controller communicatively coupled to a plurality of switches, the battery system controller storing instructions that when executed cause the battery system controller to:
communicate a set of signals to the plurality of switches to isolate or connect one or more of the first battery pack and the second battery pack to the converter/inverter controller.

13. The drivetrain of claim 12, wherein the battery system controller stores instructions that when executed cause the battery system controller to communicate a set of signals to the plurality of switches to isolate both the first battery pack and the second battery pack from the converter/inverter controller.

14. The drivetrain of claim 12, wherein the battery system controller stores instructions that when executed cause the battery system controller to communicate a set of signals to the plurality of switches to connect the first battery pack and the second battery pack in parallel to the converter/inverter controller.

15. The drivetrain of claim 12, further comprising a set of sensors, wherein:
the set of sensors comprises a first battery temperature sensor and a second battery temperature sensor; and
the battery system controller stores instructions that when executed cause the battery system controller to:
communicate with the first battery temperature sensor to determine a first battery temperature, wherein:
if the first battery temperature equals or exceeds a first battery maximum temperature threshold:
communicate a set of signals to the plurality of switches to isolate the first battery pack; and
communicate with the second battery temperature sensor to determine a second battery temperature, wherein:
if the second battery temperature equals or exceeds a second battery maximum temperature threshold:
communicate a set of signals to the plurality of switches to isolate the second battery pack.

16. The drivetrain of claim 12, further comprising a set of sensors, wherein:
the set of sensors comprises a first battery pressure sensor and a second battery pressure sensor; and
the battery system controller stores instructions that when executed cause the battery system controller to:
communicate with the first battery pressure sensor to determine a first battery pressure, wherein:
if the first battery pressure equals or exceeds a first battery maximum pressure threshold, the battery system controller stores instructions that when executed cause the battery system controller to communicate a set of signals to the plurality of switches to isolate the first battery pack; and
communicate with the second battery pressure sensor to determine a second battery pressure, wherein:
if the second battery pressure equals or exceeds a second battery maximum pressure threshold, the battery system controller stores instructions that when executed cause the battery system controller to communicate a set of signals to the plurality of switches to isolate the second battery pack.

17. The drivetrain of claim 12, further comprising a set of sensors, wherein:
the set of sensors comprises a first battery voltage sensor and a second battery voltage sensor; and
the battery system controller stores instructions that when executed cause the battery system controller to:
communicate with the first battery voltage sensor to determine a first battery voltage, wherein:
if the first battery voltage is less than a battery minimum voltage threshold, the battery system controller stores instructions that when executed cause the battery system controller to communicate a set of signals to the plurality of switches to isolate the first battery pack; and
communicate with the second battery voltage sensor to determine a second battery voltage, wherein:
if the second battery voltage is less than the battery minimum voltage threshold, the battery system controller stores instructions that when executed cause the battery system controller to communicate a set of signals to the plurality of switches to isolate the second battery pack.

18. The drivetrain of claim 12, further comprising a set of sensors, wherein:
the set of sensors comprises a first battery current sensor and a second battery current sensor; and
the battery system controller stores instructions that when executed cause the battery system controller to:
communicate with the first battery current sensor to determine a first battery current, wherein:
if the first battery current is less than a battery minimum current threshold, the battery system controller stores instructions that when executed cause the battery system controller to communicate a set of signals to the plurality of switches to isolate the first battery pack; and
communicate with the second battery current sensor to determine a second battery current, wherein:
if the second battery current is less than a battery minimum current threshold, the battery system controller stores instructions that when executed cause the battery system controller to communicate a set of signals to the plurality of switches to isolate the second battery pack.

19. The drivetrain of claim 12, further comprising a set of sensors, wherein:
the set of sensors comprises a first battery accelerometer and a second battery accelerometer; and
the battery system controller stores instructions that when executed cause the battery system controller to:
communicate with the first battery accelerometer to determine a force applied to the first battery pack, wherein:
if the force applied to the first battery pack is greater than a battery maximum force threshold, the battery system controller stores instructions that when executed cause the battery system controller to communicate a set of signals to the plurality of switches to isolate the first battery pack; and
communicate with the second battery accelerometer to determine a force applied to the second battery pack, wherein:
if the force applied to the second battery pack is greater than the battery maximum force threshold, the battery system controller stores instructions that when executed cause the battery system controller to communicate a set of signals to the plurality of switches to isolate the second battery pack.

20. The drivetrain of claim 12, further comprising:
an engine; and
a drivetrain configuration controller communicatively connected to the engine and the battery system controller, wherein
the battery system controller stores instructions that when executed cause the battery system controller to:
if one or more of the first battery pack and the second battery pack are isolated, communicate a signal to the drivetrain configuration controller whereby the drivetrain configuration controller communicates a set of signals to operate the engine; or
if the first battery pack and the second battery pack are connected in series, communicate a signal to the drivetrain configuration controller whereby the drivetrain configuration controller communicates a set of signals to power down the engine.

21. The drivetrain of claim 12, wherein the battery system controller executes instructions to perform a pre-charge routine prior to connecting the first battery pack, the second battery pack, or a combination thereof to the converter/inverter controller.

22. A method for configuring a drivetrain in a vehicle, the drivetrain comprising a motor/generator (M/G) operable as a motor to receive electric power to generate rotational power and a battery system comprising a converter/inverter controller for controlling electric power supplied to the M/G, a first battery pack and a second battery pack, wherein each of the first battery pack and the second battery pack is configured to provide electric power at a battery voltage to the converter/inverter controller, the method comprising:
communicating a set of signals to a plurality of switches to perform one of:
isolating the first battery pack; isolating the second battery pack; or connecting the first battery pack and the second battery pack with the converter/inverter controller.

23. The method of claim 22, wherein communicating the set of signals to the plurality of switches connects the first battery pack and the second battery pack in parallel to the converter/inverter controller.

24. The method of claim 22, wherein the vehicle comprises a set of sensors for detecting operating conditions of the first battery pack and the second battery pack, the method comprising:
communicating with each sensor in the set of sensors to detect a set of operating conditions of the first battery pack and the second battery pack; and
determining there is a fault condition with both the first battery pack and the second battery pack; and
communicating a set of signals to the plurality of switches to isolate both the first battery pack and the second battery pack from the converter/inverter controller.

25. The method of claim 24, wherein:
the set of sensors comprises a first battery temperature sensor, a first battery pressure sensor, a first battery accelerometer, a second battery temperature sensor, a second battery pressure sensor, and a second battery accelerometer; and
the method comprises:
communicating with the first battery temperature sensor to determine a first battery temperature, wherein:
if the first battery temperature equals or exceeds a battery maximum temperature threshold, the method comprises:
communicating a set of signals to the plurality of switches to isolate the first battery pack from the converter/inverter controller; and
communicating with the second battery temperature sensor to determine a second battery temperature, wherein:
if the second battery temperature equals or exceeds the battery maximum temperature threshold, the method comprises communicating a set of signals to the plurality of switches to isolate the second battery pack from the converter/inverter controller.

26. The method of claim 24, wherein:
the set of sensors comprises a first battery pressure sensor and a second battery pressure sensor; and
the method comprises:
communicating with the first battery pressure sensor to determine a first battery pressure, wherein:
if the first battery pressure equals or exceeds a battery maximum pressure threshold, the method comprises communicating a set of signals to the plurality of switches to isolate the first battery pack from the converter/inverter controller; and
communicating with the second battery pressure sensor to determine a second battery pressure, wherein:
if the second battery pressure equals or exceeds the battery maximum pressure threshold, the method comprises communicating a set of signals to the plurality of switches to isolate the second battery pack from the converter/inverter controller.

27. The method of claim 24, wherein:
the set of sensors comprises a first battery voltage sensor and a second battery voltage sensor; and
the method comprises:
communicating with the first battery voltage sensor to determine a first battery voltage, wherein:
if the first battery voltage is less than a battery minimum voltage threshold, the method comprises communicating a set of signals to the plurality of switches to isolate the first battery pack from the converter/inverter controller; and
communicating with the second battery voltage sensor to determine a second battery voltage, wherein:
if the second battery voltage is less than the battery minimum voltage threshold, the method comprises communicating a set of signals to the plurality of switches to isolate the second battery pack from the converter/inverter controller.

28. The method of claim 24, wherein:
the set of sensors comprises a first battery current sensor and a second battery current sensor; and
the method comprises:
communicating with the first battery current sensor to determine a first battery current, wherein:
if the first battery current is less than a battery minimum current threshold, the method comprises communicating a set of signals to the plurality of switches to isolate the first battery pack from the converter/inverter controller; and
communicating with the second battery current sensor to determine a second battery current, wherein:
if the second battery current is less than the battery minimum current threshold, the method comprises communicating a set of signals to the plurality of switches to isolate the second battery pack from the converter/inverter controller.

29. The method of claim 24, wherein:
the set of sensors comprises a first battery accelerometer and a second battery accelerometer; and
the method comprises:
communicating with the first battery accelerometer to determine a force applied to the first battery pack, wherein:
if the force applied to the first battery pack equals or exceeds a battery maximum force threshold, the method comprises communicating a set of signals to the plurality of switches to isolate the first battery pack from the converter/inverter controller; and
communicating with the second battery accelerometer to determine a force applied to the second battery pack, wherein:
if the force applied to the second battery pack equals or exceeds the battery maximum force threshold, the method comprises communicating a set of signals to the plurality of switches to isolate the second battery pack from the converter/inverter controller.

30. The method of claim 22, further comprising the converter/inverter controller performing a pre-charge routine prior to connecting the first battery pack, the second battery pack, or a combination thereof to the converter/inverter controller.
